(19) United States
(12) Patent Application Publication
(10) Pub. No.: US 2004/0183330 A1
(43) Pub. Date: Sep. 23, 2004

(54) Assembly unit for insertion into a mounting hole and instrument panel for receiving assembly unit

(76) Inventors: Roland Ruegenberg, Bad Sobernheim (DE); Norbert Swidersky, Heidesheim (DE)

Correspondence Address: JACOBSON HOLMAN PLLC, 400 SEVENTH STREET N.W., SUITE 600, WASHINGTON, DC, 20004, US

(21) Appl. No.: 10/479,862

(22) PCT Filed: Jun. 5, 2002
(86) PCT No.: PCT/EP02/06176

(30) Foreign Application Priority Data
Jun. 6, 2001 (DE) 101 27 342.8

(51) Int. Cl. B62D 25/14

(52) U.S. Cl. 296/70

(57) ABSTRACT

The invention relates to an assembly unit (1), embodied, for example, as a switch bank, which can be inserted into the mounting hole (12) of an instrument panel (11). The assembly unit (1) has laterally elastic, locking elements (9) which engage with complementary locking shoulders of the instrument panel (11). On the opposite side, the assembly unit (1) has a restraining shoulder (19). In the centre, the assembly unit is supported by a tilting bearing (e.g. 21) with a supporting force (S). Said bearing turns the tension force (S) of the locking elements into a restraining force (R), which presses the restraining shoulder (19), counter to the direction of insertion, against a stop surface (20) at the back of the instrument panel (11). The thus fixed assembly unit (1) can be released from the mounting hole (12) by exerting significant pressure on the upper side (3) of said unit, near the restraining shoulder (19).

This invention pertains to a mounting unit for installing into a mounting hole, especially an instrument board for installing the mounting unit of a vehicle, as well as an instrument board for receiving the mounting unit, wherein the mounting unit comprises at least one locking element which is spring-supported at the mounting unit and movable transversely to the direction of installation, in order to grip a locking shoulder of a wall section of a mounting hole from the rear, and wherein the mounting unit comprises a support bearing at its installation side for attaching to a thrust bearing of the instrument board, and wherein the mounting unit on the side opposite the locking element comprises a backstop shoulder.

It is common to provide a mounting unit which, for example, is formed as a switch block with expanding hooks which are spring-mounted transversely to the direction of installation, which positively interlock behind the stop surfaces of the instrument board after installation of the mounting unit, in which a minimum height play must be maintained for the safe rebound travel of the expansion hooks. In order to remove the switch block, the expansion hooks must be pushed back by means of a tool to be inserted through the though auxiliary openings.

Furthermore, it is common to provide the mounting units with spring-mounted locking hooks which are force-locked with corresponding counter-diagonals of the instrument board. The locking hooks are provided at only one side of the mounting unit. On the opposite side, the parts comprise alternate joint-like interlocking forms which overlap when installing the mounting unit at an angle and engage said unit from the rear when pivoting into locking position. Further, the interlocking forms form a fixed lateral bearing surface on which the angular mounting unit is supported. This requires a corresponding interfering marginal gap on the opposite side of the mounting unit, in order to be able to install the mounting unit in its diagonal width. In order to remove the flush installed mounting unit, a tool, for example, similar to a screwdriver is required, which is inserted into the on the marginal gap, in order to compensate for the swing-out force which increases the return friction, as a result of which visible damage may occur to the surface.

It is the object of the present invention especially to facilitate the removal the component.

The foregoing object of the invention is achieved according to Claim 1. The mounting unit now is no longer positively locked on the side opposite the locking elements, but fixed force-locked. When installing the mounting unit, the backstop shoulder can initially be engaged by tilting the unit. Subsequently, by pressing onto the detent, the mounting unit is pivoted and locked until said unit stops at the thrust bearing. This offers a major advantage in that the mounting unit slides across the fixed tilt bearing and easily centers in its installation position with negligible lateral play.

This connection can easily detached by pressing onto the backstop side. In doing so, the mounting unit pivots around the thrust bearing, and the locking diagonal slides back on the locking shoulder, during which the locking element is guided in the direction of the mounting unit. The locking geometry, the position of the tilting axle and the elastic force are so formed and configured or balanced that a considerably greater force is required for detaching the connection then depressing the operator switch. Furthermore, the ejection force is strengthened by the frictional force which is created by the locking diagonal. By this method, the mounting unit, while offering a high degree of position security during operation, can be detached by a simple manual operation, without incurring costs for tools and the risk of damage.

In an advantageous improvement of the invention, the following characteristic features arise from Claims 2 through 8.

The locking element according to Claim 2 may be formed at housing without considerable expenditure for production. With an extensive travel of the spring, the thin locking element according to Claim 3 requires less installation space and can optimally be adjusted to the bending and locking conditions. A particularly high degree of flexibility is produced in the back of the housing when bracing a bent back section of the locking element.

The locking elements according to Claim 5 favors the even installation of s strip-shaped mounting unit and provide a safe fix across their entire length.

The centering pins according to Claim 6 may be so formed that they lock into the centering slots only at the end of the pivoting motion, so that initially the mounting unit can be attached asymmetrically, in order to engage the backstop. In mounted condition, the low-travel centering means secure the mounting unit in a defined installation position in which the marginal gap is equally wide on either side.

The stop bar according to Claim 7 prevents the thin mounting unit from bending between the front end stop faces.

The rounded edges according to Claim 8 reduce the blocking width of the housing in the slanted tilting position.

The invention according to Claim 9 relates to an instrument board which has been modified in terms of the mounting unit. Normally, said-board comprises depth stops which are variably distributed or arranged, which prevent the mounting unit from being inserted deeper that the depth stop. According to the invention, the mounting unit can project through the section which is not engaged and be pivoted, enable easier installation and removal of the unit.

The locking shoulder according to Claim 10, while providing good dimensional stability, enables a defined attachment at the locking diagonal of the locking element.

The enforcements according to Claim 11 support the end section of the support bar with the greatest load.

The clear spaces according to Claim 12 make corresponding narrowing clear spaces in the housing of the mounting unit superfluous, thus enabling the unrestricted use of said clear spaces for receiving the function elements.

An embodiment of the invention is presented in the drawing and explained in detail in the following. Of the figures,

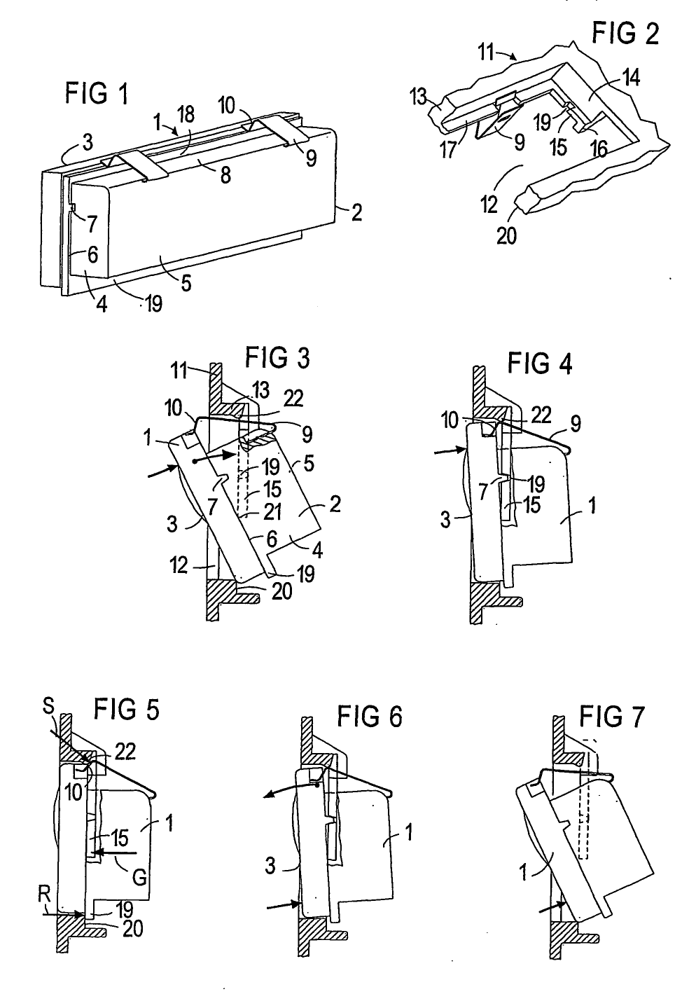

FIG. 1 shows a perspective view of a switch block for installation into an instrument board of a vehicle,

FIG. 2 shows a perspective partial view of the instrument board with a mounting hole,

FIG. 3 shows a section through the instrument board with the switch block in a first installation phase,

FIG. 4 shows the parts according to FIG. 3 in an intermediate phase of installation,

FIG. 5 shows the parts according to FIG. 3 in an assembled condition,

FIG. 6 shows the parts according to FIG. 5 at the start of the removal phase,

FIG. 7 shows the parts according to FIG. 5 at the end of the removal phase.

According to FIG. 1, a mounting unit 1 is formed as an efficient oblong switch block. A housing 2 of the mounting unit 1 at its upper side 3, which is covered, is provided with operating and display elements. The face 4 of the mounting unit 1 the housing 2 comprises shoulder-like stop surfaces 6, which face away from the upper side 3 and face the installation side 5, from which centering pins 7 project in the direction of installation. At a long side 8 of the housing 2 two bent locking elements 9 made of spring sheet are placed in the proximity of the face 4. Said elements project from the installation side 5, which is formed by the base of the housing 2, in the direction of the upper side 3 and are braced diagonally from the long side 8. In the proximity the free end of said elements, a stop diagonal 10 is lifted towards the housing 2. At the height of the stop surfaces 6, along the long side 8, the housing 2 comprises a bar-like stop shoulder 18 which projects towards the outside. On the long side, opposite said side, the housing 2 comprises a bar-like backstop shoulder 19 which projects towards the outside.

FIG. 2 shows a section of an instrument board 11 with a mounting hole 12 for receiving the mounting unit 1, of which one of the locking elements 9 is shown, the locking diagonal 10 of which butts against the longitudinal sidewall 13 of the mounting hole 12. In a front end sidewall 14, inward pointing support bars 15 are formed for the stop-surfaces 6, which extend from the longitudinal sidewall across more than one half of the width of the front end sidewall 14 and at this end are supported by rib-like enforcements 16. Centering slots 19 in the support bars 15 serve to receive the centering pins 7. Along the longitudinal sidewall 13, at the height of the support bars 15, an inward pointing stop bar 17 is attached for the stop shoulder 18, wherein the support bar 17 comprises clear spaces for the stop elements 9. At the underside the clear spaces, opposite the sidewalls, the stop elements serves as a support surface 20 for the backstop shoulder 19.

According to FIG. 3, the mounting unit 1, being in severe tilting position, is partially installed into the mounting hole 12, in which parts of the housing 2 are projected between the support surface 20 and the extremities 21 of the support bars 15, and the stop surface 6 is attached at the extremities 21 of the support bars 15, and in which these extremities 21 form a tilting axle for the mounting unit 1, which extends in the longitudinal direction. The locking element 9 in its entirety is braced towards the outside and, under minimal stress, butt against to a detent 22 which projects cam-like from the longitudinal sidewall 13 towards the locking element 9. An arrow pointing toward the upper side 3 represents a manual force of pressure which is applied to the mounting unit 1 in the proximity of the locking element 9. Said force effects a tilting motion in the direction of the bent arrow of motion.

As a result, the mounting unit 1 is pivoted in the position shown in FIG. 2, in which most of the centering pins 7 have entered the centering slots 19. The caps of the detent 22 and the locking diagonal 10 stand on top of each other, and the locking element 9 is tilted strongest in the direction of the housing. Previously, while the detent moved on the diagonal side of the locking element 9, the force of compression increased continuously and just prior to that reached its maximum level. After traveling an additional short distance the mounting unit 1 is able to snap into its installation position.

This is shown in FIG. 5. As indicated by the slanted arrow, the detent 22 with a tension force S pushes against the locking diagonal 10 of the spring-supported locking element 9 pushing towards the outside. Said element pushes the housing 2 with its stop surfaces 6 against the support bars 15. Further, the backstop shoulder 19 positively locks, gripping the support surface 20 from the rear, and thus is maintained in the defined installation position. If ideally the extremities 21 of the support bars 15 form a point-like thrust bearing, this produces a counterforce G and a rebound force R which, together with the tension force S, keeps the mounting unit 1 in a stable installation position.

According to FIG. 6, due to the strong manual pressure applied to the rebound side, the mounting unit 1 has been pivoted back into the position shown in FIG. 2 by inclining the locking element 9 by means of the locking diagonals 10 inclined towards the direction of pivot. By continuously reducing the pressure applied to the upper side 3, according to the slanted arrow of motion the mounting unit 1 is removed from a clamped position and moved into removal position according to FIG. 5 which corresponds to that in FIG. 1, in which position said unit can be removed immediately.

### Reference Symbols

1 Mounting unit

2 Housing

3 Upper side

4 Face

5 Installation side

6 Stop surface

7 Centering pin

8 Long side

9 Locking element

10 Locking diagonal

11 Instrument board

12 Mounting hole

13 Longitudinal sidewall

14 Front end face

15 Support bar

16 Enforcement

17 Stop bar

18 Stop shoulder

19 Backstop shoulder

20 Support surface

21 Extremity of the support bar

22 Detent

1. Wall section, especially that of an instrument board (11) of a motor vehicle, comprising a mounting hole (12) for receiving the mounting unit (1) which on one side comprises at least one locking element (9) which is spring-supported at the mounting unit (1) and movable transversely to the direction of installation, and at its installation side (5), which faces the wall section, comprises a backstop shoulder (19) on the other side opposite the locking element (9), in order to attach the wall section, wherein the spring-supported, bracing locking element (9), while under prestress which acts from one side to the other, can be engaged with a locking shoulder (22) of the wall section of the mounting hole (12), and wherein the locking element (9) an inclined locking diagonal (10), characterized in that the mounting hole (12) of the wall section comprises support bars (15) which run from one side to the other, which end in the center area between one side and the other side and form a thrust bearing for a stop surface (6) which run from one side to the other of the mounting unit (1), which is spaced in the intermediate area between the locking element (9) and the backstop shoulder (19), and one section not touched by the support bar (15), which is located between the free extremities of the support bar (15), and the other side of the mounting hole (12) is greater than the thickness of a housing section of the mounting unit (1), which is located across the stop surface (6).

2. Wall section as defined in claim 1, characterized in that the support bar (15) comprises a center slot (19) for receiving a centering pin (7) projecting from the stop surface (6).

3. Wall section as defined in claim 2, characterized in that at the stop surfaces (6), which run from one side to the other side of the mounting unit (1), form the faces (4) of a housing (2) of the mounting unit (1), which extend transversally to the tilting axle.

4. Wall section as defined in claim 3, characterized in that the housing (2) of the mounting unit (1) on one side of the mounting unite (1) at the height of the stop surfaces (6) comprises a bar-like stop shoulder (18) for attaching on one the side of the mounting hole (12).

5. Wall section as defined in claim 3 or 4, characterized in that the housing (2) of the mounting unit (1) comprises a strongly rounded longitudinal edge between the housing base installed in the mounting hole (12) and the long side (8) supporting the locking elements.

6. Wall section as defined in one of the claims 1 though 5, characterized in that the locking shoulder (22) is formed as a projecting detent (22) which runs along one side of the mounting hole (12) along the longitudinal sidewall (13), which is provided with A rounded locking cup for attaching to the locking diagonal (10) of the locking element (9) of the installed mounting unit (1).

7. Wall section as defined in one of the claims 1 though 6, characterized in that the support bar (15) is formed by a sidewall (14) of the mounting hole (12), which projects from one side to the other side of the mounting hole (12), and that the sidewall (14) at the free extremity (21) of the formed support bar (15) comprises a ribbed enforcement (16).

8. Wall section as defined in one of the claims 4 though 7, characterized in that a stop bar (17) for the stop shoulder (18) of the housing (2) of the mounting unit (1), which runs along one side of the mounting hole (12), comprises a clear space for the stop element (9).
